(19) United States
(12) Patent Application Publication
(10) Pub. No.: US 2025/0157190 A1
(43) Pub. Date: May 15, 2025

(54) AUTOMATED SHOPPING USING AUGMENTED REALITY

(71) Applicant: Motorola Mobility LLC, Chicago, IL (US)

(72) Inventors: Krishnan Raghavan, Bangalore (IN); Vignesh Karthik Mohan, Bangalore (IN); Nakul Patel, Bangalore (IN)

(73) Assignee: Motorola Mobility LLC, Chicago, IL (US)

(21) Appl. No.: 18/388,934

(22) Filed: Nov. 13, 2023

(51) Int. Cl. G06V 10/764; G06T 19/00

(52) U.S. Cl. CPC G06V 10/764; G06T 19/006

(57) ABSTRACT

In aspects of automated shopping using augmented reality, a mobile device detects an item in an image captured by a camera of a mobile device, and identifies, via augmented reality, that the item is on a list of monitored items that are replenished based on automated ordering. The mobile device determines that a remaining quantity of the item is less than a reorder threshold, from which an automated order of the item is initiated. A network device receives, from the mobile device, an identification of an item and a remaining quantity of the item, determines that the remaining quantity of the item is less than a reorder threshold, from which an automated order of the item is initiated, and adds the item to a shopping list based on the determination. The network device processes the automated order based on receiving an approval of the shopping list.

### BACKGROUND

Automation includes a wide range of technologies that reduce human intervention in processes, namely by predetermining decision criteria, subprocess relationships, and related actions, as well as embodying those predeterminations in machines. Augmented reality (AR) combines the real world with computer-generated content, and can alter an ongoing perception of a real-world environment based on the computer-generated content. The content can span multiple sensory modalities, including visual, auditory, haptic, somatosensory, and/or olfactory. Augmented reality can be defined as a computer hardware that incorporates a combination of features such as real and virtual worlds, real-time interaction, and/or accurate three-dimensional registration of virtual and real objects. Augmented reality can include computer-generated content over live images of a real-world environment. The overlaid content can be constructive (e.g., additive to the natural environment), or destructive (e.g., masking of the natural environment). Augmented reality is seamlessly interwoven with the physical world such that it is perceived as an immersive aspect of a real-world environment.

### BRIEF DESCRIPTION OF THE DRAWINGS

Implementations of the techniques for automated shopping using augmented reality are described with reference to the following Figures. The same numbers may be used throughout to reference like features and components shown in the Figures.

FIG. 1 illustrates an example system for automated shopping using augmented reality in accordance with one or more implementations as described herein.

FIG. 2 further illustrates an example of automated shopping using augmented reality in accordance with one or more implementations as described herein.

FIGS. 3-6 illustrate example methods for automated shopping using augmented reality in accordance with one or more implementations of the techniques described herein.

FIG. 7 illustrates various components of an example device that may be used to implement the techniques for automated shopping using augmented reality as described herein.

### DETAILED DESCRIPTION

Implementations of the techniques for automated shopping using augmented reality may be implemented as described herein. A mobile device such as any type of a wireless device, mobile device, mobile phone, flip phone, client device, wearable computing device, camera device, tablet, computing device, communication device, entertainment device, and/or any other type of computing, consumer, and/or electronic device, or a system of any combination of such devices, may be configured to perform techniques for automated shopping using augmented reality as described herein. In some cases, at least one mobile device implements an instantiation of a smart shopping controller, enabling the smart shopping functionality described herein.

Grocery shopping can be a dreaded, but also important activity. Grocery shopping involves keeping a schedule, listing what is needed, and remembering to bring the list when shopping. However, grocery shopping involves common issues such as forgetting to add an item to the shopping list and/or over ordering. At times, a person may not be aware of what grocery items will soon run out, what grocery items are going to run out relatively soon, or what grocery items have run out and need replacing. As a result, a grocery item has often run out when one desires to use it. Additionally, one often adds items to the cart at the grocery store that are not on the shopping list and/or one adds an item to the shopping cart that does not need replacing. As a result, a person may end up with more of the item than is needed and when the item is perishable, the item may be wasted or expire before consumption.

In one example, a person and spouse may share the responsibility of grocery shopping for their household. While the spouse is responsible for all essential items like pulses, grains, and spices, the person takes care of all the other one-off items, such as the tea, batter, sauces, and spreads, etc. The person has some guests over and offers to make sandwiches based on a new sandwich recipe. Everyone is excited and accepts the offer. The person gets to work in the kitchen, but soon realizes that most of the sauces or spreads have run out, and has to inform the guests that plans have changed. A little disappointment and lot of embarrassment follows, not just because of the broken expectations, but also because the person comes across as someone who is not well organized in front of guests.

In another example, a person has been tasked with ordering groceries for a given month. Unfortunately, the person does not have a ready list of items that need to be ordered and struggles with identifying the items that are running low or have run out and searching for the correct items (brands, variants, etc.) on a regular grocery shopping application. This may result in multiple trips to the kitchen and pantry, and a relatively high number of search terms in the grocery shopping application. Once the shopping list is finalized and the order placed, the person may still find missing items, or items that are about to run out, when the order is delivered, which can be a frustrating user experience. Such problems are avoidable by the smart shopping functionality of the smart shopping controller. The smart shopping functionality described herein automates determining what grocery and/or household items to add to a shopping list based on a determined need for each item and adds them as recommendations to the shopping list. The smart shopping controller uses augmented reality to passively monitor grocery and/or household items to determine which of the items are running out and automates generation of a shopping list accordingly.

In aspects of the described techniques, a smart shopping controller implements augmented reality to enable smart shopping functionality. In one or more examples, the smart shopping functionality is performed via at least one mobile device that implements an instantiation of a smart shopping controller. In some cases, user input is captured by the mobile device.

In implementations, the smart shopping controller can determine which items to order and how much of each item to order. In one or more examples, the smart shopping controller monitors grocery and/or household items that a user regularly orders (e.g., based on previous orders and/or grocery shopping lists). The smart shopping controller includes augmented reality functions. For example, the smart shopping controller is implemented in a mobile device (e.g., a smartphone) and/or a wearable computing device (e.g., computing glasses, a smart watch, smart jewelry, etc.) with augmented reality. The smart shopping controller uses augmented reality to monitor items in a household (e.g., items in kitchen, pantry, utilities, storage) as a user follows their given routines about the household. The smart shopping controller detects a grocery or household item and determines the remaining quantity of the item. For example, the smart shopping controller determines an amount of an item remaining in a transparent container. Additionally or alternatively, the smart shopping controller determines an amount of an item based on a perspective of looking down into the container and measuring a depth and/or volume of the item relative to the overall depth and/or volume of the container. The smart shopping controller populates a shopping list based on the passive monitoring of items. In some cases, the smart shopping controller sends a grocery or household item and a determined remaining quantity of the item to a remote device (e.g., a network device, a cloud device, remote server, remote database, etc.). The smart shopping controller determines whether the determined remaining quantity of an item triggers adding the item to the shopping list. For example, when the smart shopping controller determines the remaining quantity satisfies a reorder threshold, the smart shopping controller adds the item to the shopping list.

In one or more examples, the reorder threshold is satisfied when the remaining amount is less than (e.g., equal to or less than) the reorder threshold. In one or more variations, the smart shopping controller considers how long a shipment of an item takes to arrive when adding the item to the shopping list. For example, when the shipping time is one week, then the smart shopping controller adds the item to the shopping list sooner (e.g., when more of the item is still remaining) compared to when the shipping time is the same day or one day. The smart shopping controller can also determine a consumption rate for a given item. As an example, when the smart shopping controller determines it takes one week for the item to arrive after placing an order, then the smart shopping controller adds the item to a shopping list when the smart shopping controller determines there are approximately 10-14 days left of the item. When the smart shopping controller determines it takes only one day for the item to arrive after placing an order, then the smart shopping controller adds the item to a shopping list when the smart shopping controller determines there are approximately 3-5 days left of the item.

In one or more examples, the smart shopping controller communicates a notification (e.g., via push notification, email, text message) indicating the addition of an item to the shopping list (e.g., adds the item to a shopping cart). The smart shopping controller highlights the one or more items added to the shopping list based on the passive monitoring via augmented reality. The smart shopping controller prompts a user to review the shopping list, modify items (e.g., add item, delete item, update quantity of item), and/or to place an order for the items in a shopping cart. To avoid ordering more than is needed, the smart shopping controller prompts the user with a notification when an item from the most recently placed order is again added to the cart by the user.

In one or more examples, the smart shopping controller identifies routine items that are consumed with some determined regularity (e.g., milk, cereal, detergent, soap, hygiene items, toothbrushes, toothpaste, etc.) and automatically places an order for a routine item after the smart shopping controller recommends ordering the routine item and the smart shopping controller determines that the user has not acknowledged the recommendation within a preset number of days (e.g., 1 or 2 days, etc.). The smart shopping controller tracks historical consumption patterns associated with monitored items and recommends adding one or more items based on associated historical consumption patterns. In one or more implementations, the smart shopping controller recommends adding one or more items to a shopping list and/or adjusts recommended amounts to an order based on one or more calendar events (e.g., upcoming vacations, number of days for a planned vacation, guest dinners, guest visits, guest overnight stays, number of nights for guest overnight stays, etc.).

While features and concepts of the described techniques for automated shopping using augmented reality are implemented in any number of different mobile devices, systems, environments, and/or configurations, implementations of the techniques for automated shopping using augmented reality are described in the context of the following example devices, systems, and methods.

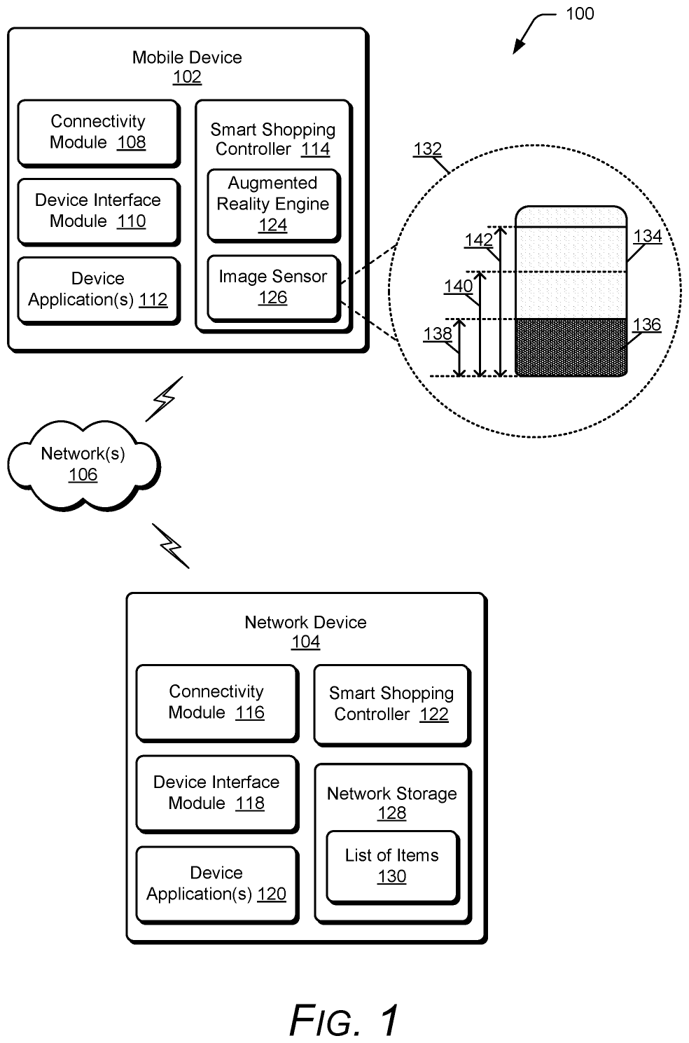

FIG. 1 illustrates an example system 100 for automated shopping using augmented reality, as described herein. The system 100 includes one or more computing devices, such as a mobile device 102 and/or a network device 104. Examples of mobile devices include at least one of any type of a wireless device, mobile device, mobile phone, flip phone, client device, wearable computing device, computer glasses, camera device, display device, tablet, computing device, communication device, entertainment device, gaming device, media playback device, and/or any other type of computing, consumer, and/or electronic device, and/or a system of any combination of such devices.

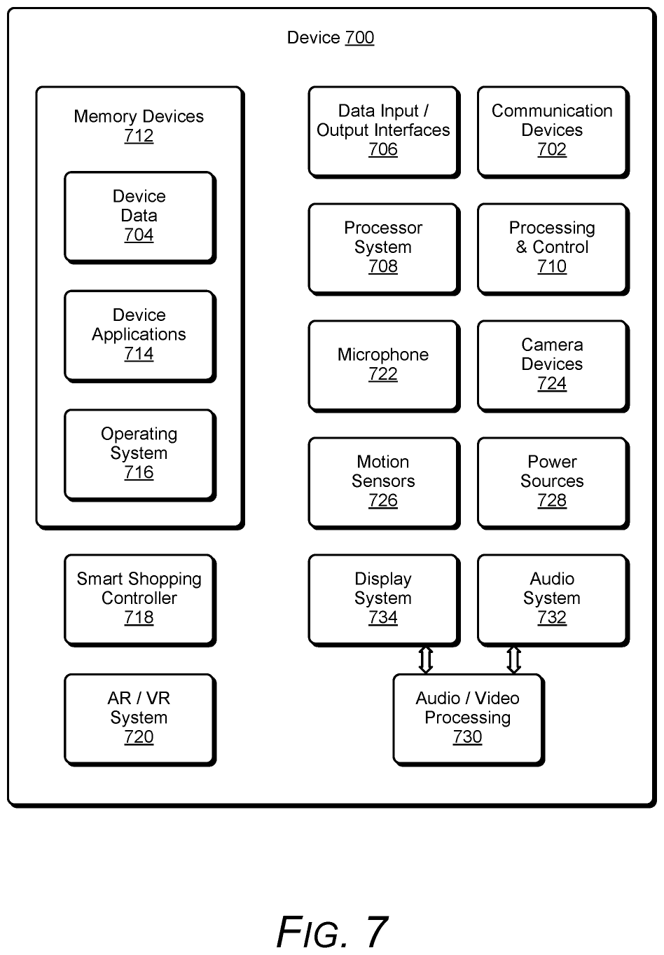

The mobile device 102 is implemented with various components, such as a processor system and memory, as well as any number and combination of different components as further described with reference to the example device shown in FIG. 7. In implementations, the mobile device 102 includes various radios for wireless communication with other devices. In one or more examples, the mobile device 102 includes at least one of a BLUETOOTH® (BT) or BLUETOOTH® Low Energy (BLE) transceiver, a near field communication (NFC) transceiver, or the like. In some cases, the mobile device 102 includes at least one of a WI-FI® radio, a cellular radio, a global positioning satellite (GPS) radio, or any available type of device communication interface.

Additionally, or alternatively, the system 100 includes a network device 104, such as any type of server, router, switch, gateway, storage device, database, laptop device, desktop device, smart device, mobile device, or any other type of computer network device. Similar to the mobile device 102, the network device 104 is implemented with various components, such as a processor system and memory, as well as any number and combination of the different components as further described with reference to the example device shown in FIG. 7. In implementations, the mobile device 102 is communicatively linked, either by a wired or wireless connection, to the network device 104. For example, the mobile device 102 and the network device 104 are communicatively linked via a communication network 106 and/or via direct inter-device connectivity, e.g., via direct wireless and/or wired connectivity between the mobile device 102 and the network device 104.

In some implementations, the devices, applications, modules, servers, and/or services described herein communicate via the communication network 106, such as for data communication between the mobile device 102 and the network device 104. The communication network 106 includes a wired and/or a wireless network. The communication network 106 is implemented using any type of network topology and/or communication protocol, and is represented or otherwise implemented as a combination of two or more networks, to include IP-based networks, cellular networks, and/or the Internet. The communication network 106 includes mobile operator networks that are managed by a mobile network operator and/or other network operators, such as a communication service provider, mobile phone provider, and/or Internet service provider.

The mobile device 102 includes various functionalities that enable the device to implement different aspects of automated shopping using augmented reality, as described herein. In the illustrated example, the mobile device 102 includes a connectivity module 108, a device interface module 110, device applications 112, and a smart shopping controller 114. The connectivity module 108 represents functionality (e.g., logic, software, and/or hardware) enabling the mobile device 102 to interconnect with other devices and/or networks, such as the network device 104 and the communication network 106. For example, the connectivity module 108 enables wireless and/or wired connectivity of the mobile device 102. The device interface module 110 represents functionality enabling the mobile device 102 to interface with other devices. As further detailed below, the device interface module 110 enables the mobile device 102 to establish wireless and/or wired data communication with other devices, such as the network device 104 or similar presentation device.

Similarly, the network device 104 includes various functionality that enables the network device 104 to implement different aspects of automated shopping using augmented reality, as described herein. In the illustrated example, the network device 104 includes a connectivity module 116 and a device interface module 118. The connectivity module 116 represents functionality (e.g., logic, software, and/or hardware) enabling the network device 104 to interconnect with other devices and/or networks, such as the mobile device 102 and the communication network 106. For example, the connectivity module 116 enables wireless and/or wired connectivity of the network device 104. The device interface module 118 represents functionality enabling the network device 104 to interface with other devices. As further detailed below, the device interface module 118 enables the network device 104 to establish wireless and/or wired data communication with other devices, such as the mobile device 102 or similar devices.

The mobile device 102 and/or the network device 104 can include and implement the device applications 112 and the device applications 120, respectively, such as any type of augmented reality application, shopping application, messaging application, email application, video communication application, cellular communication application, music/audio application, gaming application, media application, social platform application, and/or any other of the many possible types of device applications. Many of the device applications 112 and/or device applications 120 have an associated application user interface that is generated and displayed for user interaction and viewing, such as on a display screen of the mobile device 102 and/or on a display of the network device 104. For example, a shopping application (e.g., a device application 112 and/or a device application 120) may have an associated application user interface on which shopping list items are displayed, as well as other user interface controls. Generally, an application user interface, or any other type of video, image, graphic, and the like is digital image content that is displayable on the display screen of the mobile device 102 and/or on the display of the network device 104.

In the example system 100 for automated shopping using augmented reality, the mobile device 102 and the network device 104 are devices that incorporate smart shopping functionality. In this example, the mobile device 102 implements the smart shopping controller 114 (e.g., as a device application 112), and similarly, the network device 104 implements an instantiation of a smart shopping controller 122 (e.g., as a device application 120). In some examples, the smart shopping controller 122 is an instance of the smart shopping controller 114. Thus, a description of the smart shopping controller 114 includes a description of the smart shopping controller 122. The smart shopping controller 114 and the smart shopping controller 122 each represent functionality (e.g., logic, software, and/or hardware) enabling implementation of described techniques for automated shopping using augmented reality. The smart shopping controller 114 and/or the smart shopping controller 122 can be implemented as computer instructions stored on computer-readable storage media and can be executed by a processor system of the mobile device 102 and/or of the network device 104, respectively. Alternatively or in addition, the smart shopping controller 114 and/or the smart shopping controller 122 can be implemented at least partially in hardware of a device.

In one or more implementations, the smart shopping controller 114 and/or the smart shopping controller 122 includes independent processing, memory, and/or logic components functioning as a computing and/or electronic device integrated with the mobile device 102 and/or with the network device 104. Alternatively or in addition, the smart shopping controller 114 and/or the smart shopping controller 122 can be implemented in software, in hardware, or as a combination of software and hardware components. In one or more examples, the smart shopping controller 114 and/or the smart shopping controller 122 is implemented as a software application or module, such as executable software instructions (e.g., computer-executable instructions) that are executable with a processor system of the mobile device 102 and/or the network device 104 to implement the techniques and features described herein. As a software application or module, the smart shopping controller 114 and/or the smart shopping controller 122 is stored on computer-readable storage memory (e.g., memory of a device), or in any other suitable memory device or electronic data storage implemented with the module. Alternatively or in addition, the smart shopping controller 114 and/or the smart shopping controller 122 is implemented in firmware and/or at least partially in computer hardware. For example, at least part of the smart shopping controller 114 and/or the smart shopping controller 122 is executable by a computer processor, and/or at least part of the smart shopping controller 114 and/or the smart shopping controller 122 is implemented in logic circuitry.

In the illustrated example, the smart shopping controller 114 implemented in the mobile device 102 includes an augmented reality engine 124 and an image sensor 126. In one or more examples, the smart shopping controller 114 provides smart shopping functionality to mobile devices based on the operations of the augmented reality engine 124 and the image sensor 126. In the illustrated example, the network device 104 includes a network storage 128 that stores at least a list of items 130 (e.g., a list of items monitored by the smart shopping controller 122).

In one or more examples, the smart shopping controller 114 detects an item in an image captured by the image sensor 126 (e.g., a camera or imaging device) of the mobile device 102. As shown, the image sensor 126 captures a live view 132 of a container 134. For example, the smart shopping controller 114 scans an environment for the monitored items in the list of items 130 and performs item detection, item identification, and/or item quantity analysis based on movement of the mobile device 102 (e.g., a wearable augmented reality device) in a given environment (e.g., a home, office, kitchen, pantry, restaurant, etc.).

In the illustrated example, the container 134 includes some measure of an item 136. In one or more variations, a user views the live view 132 (e.g., through a lens of smart glasses, computer glasses, augmented reality goggles) while the image sensor 126 captures one or more images of the live view. Additionally or alternatively, the mobile device 102 displays at least a portion of the live view 132 on a display of the mobile device 102 and/or relays the live view 132 to a remote device (e.g., the network device 104). The live view 132 includes a view through a lens of smart glasses and/or a live camera feed displayed on a screen.

In the illustrated example, the smart shopping controller 114 identifies, via the augmented reality engine 124, that the item 136 is on the list of items 130 (e.g., list of monitored items) that are replenished based on automated ordering. The augmented reality engine 124 determines whether a remaining quantity of the item 136 satisfies (e.g., is less than, is less than or equal to) a reorder threshold. When the augmented reality engine 124 determines that the remaining quantity of the item 136 satisfies the reorder threshold, the smart shopping controller 114 initiates an automated order of the item 136. For example, the smart shopping controller 114 adds the item 136 to an existing shopping list or creates a new shopping list and adds the item 136 to the new shopping list.

In one or more implementations, the smart shopping controller 114 determines the remaining quantity of the item utilizing the augmented reality functions of the augmented reality engine 124 for image analysis of one or more previously captured images that include a depiction of the item 136. In one or more instances, the smart shopping controller 114 displays, over a depiction of the item 136, an item identifier (e.g., wheat, barley, cinnamon, etc.). Additionally or alternatively, the smart shopping controller 114 displays over a depiction of the item 136 at least one of an indication of the remaining quantity of the item or a visual indicator of the reorder threshold relative to the remaining quantity of the item. In one or more examples, the depiction of the item 136 includes the live view 132 of the item 136. Thus, displaying information (e.g., indicators, information, graphics etc.) over the depiction of the item 136 includes displaying information over a live view of the item 136 (e.g., via smart glasses).

In one or more variations, the augmented reality engine 124 detects, via the image sensor 126, a remaining amount of the item 136. The augmented reality engine 124 determines an amount remaining of the item 136 based on analysis of one or more images of the item 136 captured by the image sensor 126. Additionally or alternatively, the augmented reality engine 124 displays at least one of an amount remaining indicator 138 (e.g., amount of the item 136 detected), a reorder threshold indicator 140, and/or a maximum amount indicator 142 on a display (e.g., on a lens of smart glasses). In some cases, the augmented reality engine 124 initiates to display the amount remaining indicator 138, the reorder threshold indicator 140, and/or the maximum amount indicator 142 over the live view 132 of the container 134 (e.g., on a lens of smart glasses). The reorder threshold indicator 140 indicates the reorder threshold for a given item. The reorder threshold for a first item (e.g., rice) is different from the reorder threshold for a second item (e.g., flour). The smart shopping controller 114 determines the reorder threshold of a given item based on one or more factors, such as historical consumption of the item, usage rates over different parts of the year (e.g., higher usage rate over winter versus summer), the average time it takes for the item to arrive after ordering the item, and the like.

In one or more implementations, the augmented reality engine 124 identifies a new item that is unaccounted for in the list of items 130. For example, as a customer is looking at a pantry while wearing smart glasses incorporating the smart shopping controller 114, the augmented reality engine 124 identifies a container that has not been previously identified. Accordingly, the augmented reality engine 124 displays an identification request over a depiction of the new item. For example, the augmented reality engine 124 displays a request for identification on the surface of a lens of the smart glasses while the user is viewing a live view of the new item through the lens of the smart glasses. The augmented reality engine 124 adds an identification of the new item to the list of items 130 based on an identification input response (e.g., text user input, spoken user input).

In one or more examples, the smart shopping controller 114 is trained by an item identification machine learning model to identify items. The smart shopping controller 114 determines an identification of the new item based on an implementation of the item identification machine learning model. Additionally or alternatively, the smart shopping controller 114 adds the new item to the list of items based on the identification of the new item via the implementation of the item identification machine learning model.

In one or more examples, the smart shopping controller 114 uploads the remaining quantity of the item 136 and an item identifier (e.g., wheat, barley, cinnamon, etc.) to one or more remote devices (e.g., the network device 104) to generate an automated order of the shopping list with the item 136 included in the order. The smart shopping controller 114 generates a shopping list and generates a notification for at least one of review, update, or confirmation of the automated order.

The smart shopping controller 114 can identify that the item 136 is at least partially concealed in the container 134. For example, the container 134 has a label that obscures the item 136 or is at least partially opaque. When the smart shopping controller 114 identifies that the item 136 is at least partially concealed, the smart shopping controller 114 displays, over a depiction of the item 136, a request to view within the container 134. Additionally or alternatively, the smart shopping controller 114 displays, over the live view 132 of the item 136 using smart glasses, a request to view within the container 134. For example, the smart shopping controller 114 requests that a lid of the container 134 be removed to view inside the container 134 from the top down. The smart shopping controller 114, via the image sensor 126, captures one or more images of the view within the container 134 and determines the remaining quantity of the item 136 based on an analysis of the remaining quantity of the item 136 relative to at least one of a depth or volume within the container 134.

The smart shopping controller 114 can identify the item 136 in a given location (e.g., pantry) and then subsequently determines that the item 136 is no longer in the given location. The smart shopping controller 114 displays a message on the mobile device 102 (e.g., on a lens of smart glasses) indicating that the item is missing from its expected location and/or asking whether to add the missing item to the shopping list, as the missing item may indicate that the item has been consumed and is due to be reordered.

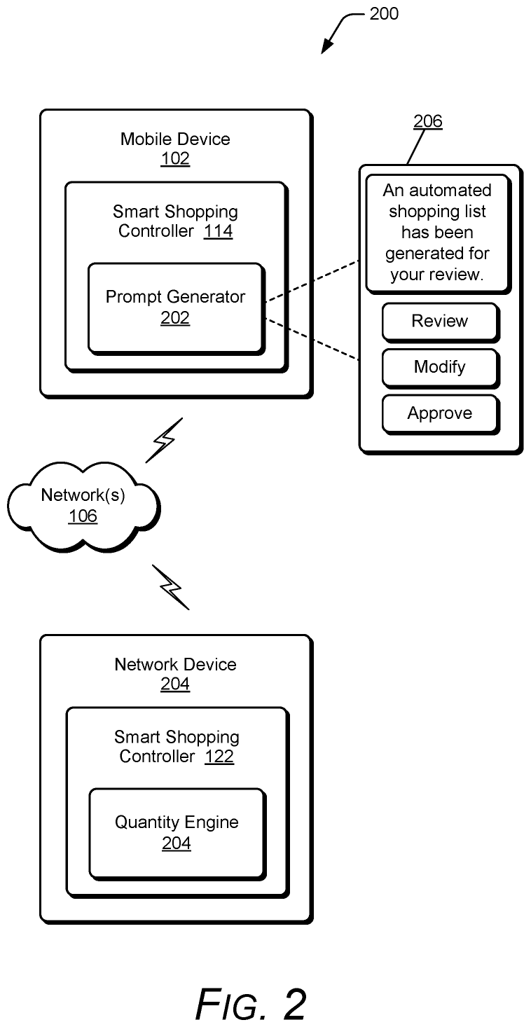

FIG. 2 illustrates example 200 of automated shopping using augmented reality, as described herein. As shown, the smart shopping controller 114 of the mobile device 102 includes a prompt generator 202, and the smart shopping controller 122 of the network device 104 includes a quantity engine 204. In one or more examples, the quantity engine 204 and/or the prompt generator 202 enables the smart shopping functionality of the smart shopping controller 114 of the mobile device 102 and/or the smart shopping controller 122 of the network device 104. Further, either or both of the smart shopping controller 114 and the smart shopping controller 122 can include both the prompt generator 202 and the quantity engine 204 to implement aspects of the techniques for automated shopping using augmented reality, as described herein.

In one or more examples, the smart shopping controller 122 of the network device 104 receives (e.g., from the mobile device 102) an identification of an item (e.g., the item 136) and a remaining quantity of the item. The smart shopping controller 122 determines that the remaining quantity of the item is less than a reorder threshold, from which the smart shopping controller initiates an automated order of the item. Additionally or alternatively, the smart shopping controller 122 adds the item to a shopping list based on the determination. In one or more variations, the smart shopping controller 122 processes the automated order based on receiving an approval of the shopping list. Additionally or alternatively, the smart shopping controller 122 adds the item to the shopping list based on an estimated time before the item arrives after ordering. Additionally or alternatively, the smart shopping controller 122 adds the item to the shopping list after the smart shopping controller recommends ordering a routinely purchased item and the smart shopping controller determines that the recommendation has not been acknowledged or accepted within a preset number of days (e.g., within 1 or 2 days, etc.).

In one or more examples, the quantity engine 204 selects a quantity of the item to add to the shopping list based on historical consumption of the item and/or one or more calendar events. The one or more calendar events include at least one of a holiday, a vacation, a guest visit, or a guest overnight stay. In one or more examples, the quantity of the item that the quantity engine 204 adds to the shopping list is based on the number of days of the vacation, the number of guests visiting (e.g., for dinner), the number of guests staying overnight, and/or the number of nights the one or more guests are staying overnight.

In one or more examples, the prompt generator 202 of the smart shopping controller 114 at the mobile device 102 generates a notification 206. For example, the prompt generator 202 generates a notification of the shopping list. In one or more examples, the smart shopping controller 122 of the network device 104 includes an instantiation of the prompt generator 202 that generates the notification 206, and transmits the notification 206 to one or more devices, such as to the mobile device 102. The notification 206 includes a user interface with one or more selectable options to perform at least a review of the shopping list, a modification of the shopping list, and/or the approval of the shopping list. Additionally or alternatively, the prompt generator 202 initiates a notification of a recommended item (e.g., based on a list of items that are regularly ordered, the list of items 130). The smart shopping controller 122 at the network device 104 adds the recommended item to the list of items 130 based on the smart shopping controller detecting the recommended item is added to the shopping list. Additionally or alternatively, the smart shopping controller 122 updates the list of items 130 based on detection of a new item being added to the shopping list.

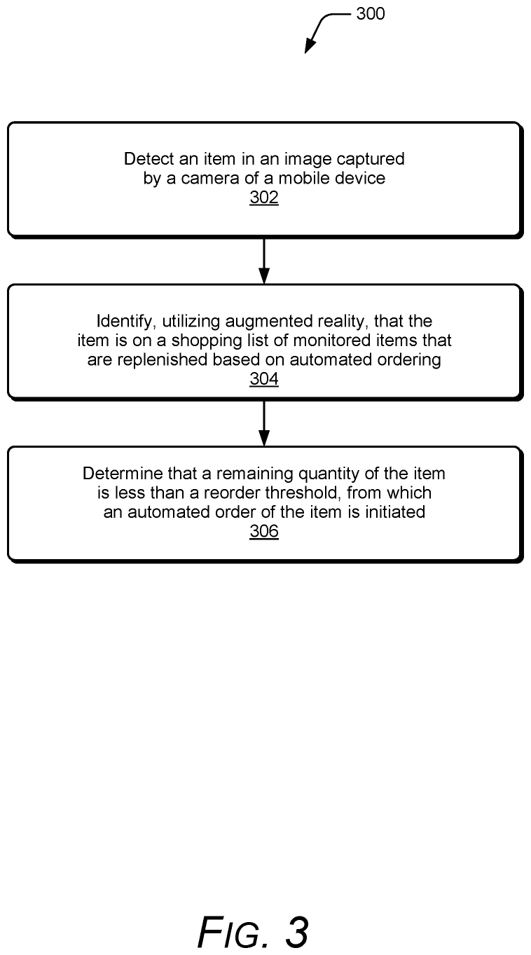

Example methods 300, 400, 500, and 600 are described with reference to respective FIGS. 3, 4, 5, and 6 in accordance with one or more implementations of automated shopping using augmented reality, as described herein. Generally, any services, components, modules, managers, controllers, methods, and/or operations described herein can be implemented using software, firmware, hardware (e.g., fixed logic circuitry), manual processing, or any combination thereof. Some operations of the example methods are described in the general context of executable instructions stored on computer-readable storage memory that is local and/or remote to a computer processing system, and one or more implementations include software applications, programs, functions, and the like. Alternatively or in addition, any of the functionality described herein is performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates example method(s) 300 for automated shopping using augmented reality. The order in which the method is described is not intended to be construed as a limitation, and any number or combination of the method operations described herein (e.g., of FIGS. 3, 4, 5, and/or 6) may be performed in any order to perform a method, or an alternate method.

At 302, an item is detected in an image captured by a camera of a mobile device. For example, the smart shopping controller 114, via the image sensor 126 of the mobile device 102, captures one or more images of an item, performs image analysis on the one or more images, and identifies an item in the image.

At 304, the item is identified, utilizing augmented reality, as being on a list of monitored items that are replenished based on automated ordering. For example, the smart shopping controller 114 identifies the item 136 and determines that the item 136 is on the list of monitored items (e.g., the list of items 130).

At 306, a determination is made that a remaining quantity of the item is less than a reorder threshold, from which an automated order of the item is initiated. For example, the smart shopping controller 114 determines a remaining quantity of the item 136 based on the image analysis performed on one or more images captured by the image sensor 126. The smart shopping controller 114 determines whether the remaining quantity of the item 136 satisfies (e.g., less than, less than or equal) the reorder threshold.

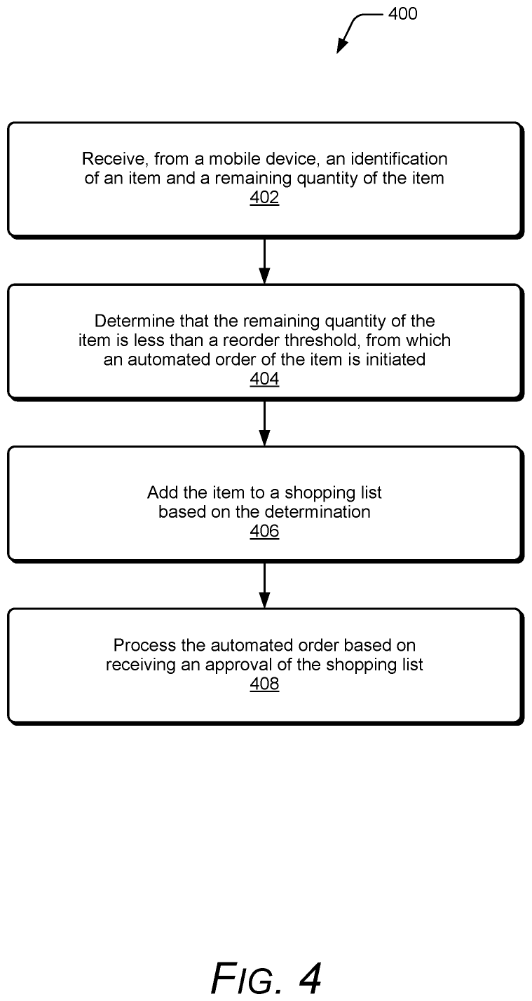

FIG. 4 illustrates example method(s) 400 for automated shopping using augmented reality. The order in which the method is described is not intended to be construed as a limitation, and any number or combination of the method operations described herein (e.g., of FIGS. 3, 4, 5, and/or 6) may be performed in any order to perform a method, or an alternate method.

At 402, an identification of an item and a remaining quantity of the item is received from a mobile device. For example, the smart shopping controller 122 of the network device 104 receives an identification of an item indicating that the item 136 is rice and a remaining quantity of the rice.

At 404, a determination is made that the remaining quantity of the item is less than a reorder threshold, from which an automated order of the item is initiated. For example, the smart shopping controller 122 compares the remaining quantity of the rice to a reorder threshold associated with the rice (e.g., a reorder threshold customized to the rice, a reorder threshold customized to the container of the rice, a reorder threshold customized to a volume of the container of the rice).

At 406, the item is added to a shopping list based on the determination. For example, the smart shopping controller 122 generates a shopping list with one or more items that includes the item 136.

At 408, the automated order is processed based on receiving an approval of the shopping list. For example, the smart shopping controller 122 (or the smart shopping controller 114) generates a prompt (e.g., the notification 206) requesting approval of the item being added to the shopping list and/or approval of the shopping list. When the shopping list is approved, the smart shopping controller 122 at the network device 104 processes an order for the items on the shopping list.

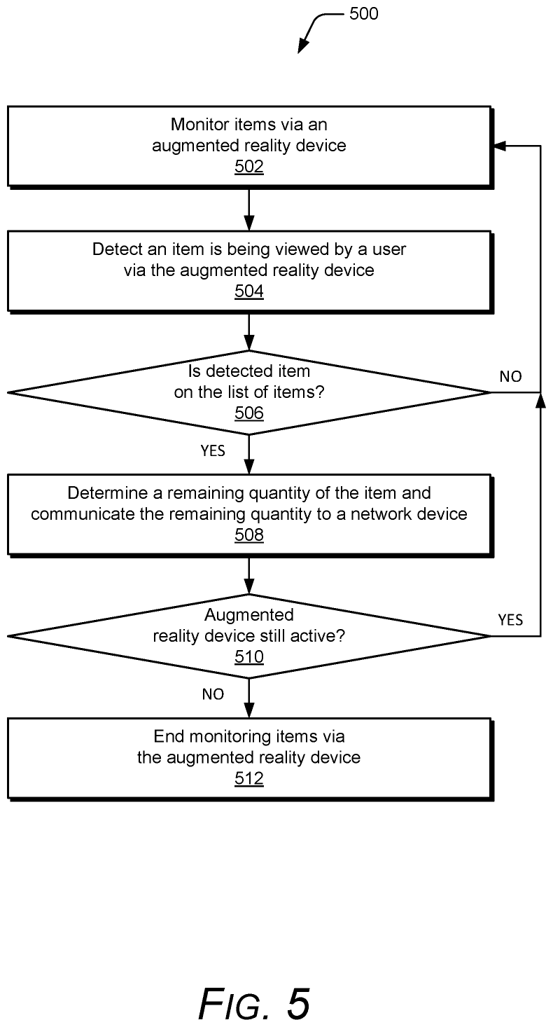

FIG. 5 illustrates example method(s) 500 for automated shopping using augmented reality. The order in which the method is described is not intended to be construed as a limitation, and any number or combination of the method operations described herein (e.g., of FIGS. 3, 4, 5, and/or 6) may be performed in any order to perform a method, or an alternate method.

At 502, items are monitored via an augmented reality device. For example, the smart shopping controller 114 at the mobile device 102 detects an augmented reality device being used and initiates a monitoring of items (e.g., the list of items 130). The smart shopping controller 114 detects that an augmented reality device (e.g., the mobile device 102, smart glasses, etc.) is being worn or carried by a user. The smart shopping controller 114 initiates the monitoring (e.g., an item identification process) based on detecting the augmented reality device being used and/or detecting the augmented reality device being activated.

At 504, an item is detected being viewed by a user via the augmented reality device. For example, the smart shopping controller 114 monitors one or more images captured by the augmented reality device (e.g., via the image sensor 126) while the user goes about his or her daily routine.

At 506, a determination is made as to whether the detected item is on the list of items. For example, the smart shopping controller 114 analyzes an image of the item 136 captured using the augmented reality device and determines whether the item is on a list of monitored items (e.g., the list of items 130). If the item is not on the list of items (i.e., “No” from 506), then at 502, the method 500 continues monitoring for items via the augmented reality device.

If the item is on the list of items (i.e., “Yes” from 506), then at 508, a remaining quantity of the item is determined and the remaining quantity is communicated to a network device. For example, the smart shopping controller 114 analyzes an image of the item and determines how much of the item is remaining based on the image analysis. The smart shopping controller 114 transmits the remaining quantity (e.g., and an identification of the item) to the network device 104.

At 510, a determination is made as to whether the augmented reality device is still active. For example, the smart shopping controller 114 detects that the user removes the augmented reality device and/or that the user deactivated the augmented reality device. If the augmented reality device is determined to be active (i.e., “Yes” from 510), then at 502, the method 500 continues monitoring for items via the augmented reality device.

If the augmented reality device is determined to be inactive (i.e., “No” from 510), then at 512, the monitoring of items via the augmented reality device is ended. For example, the smart shopping controller 114 ends the item identification process based on detecting the augmented reality device is inactive.

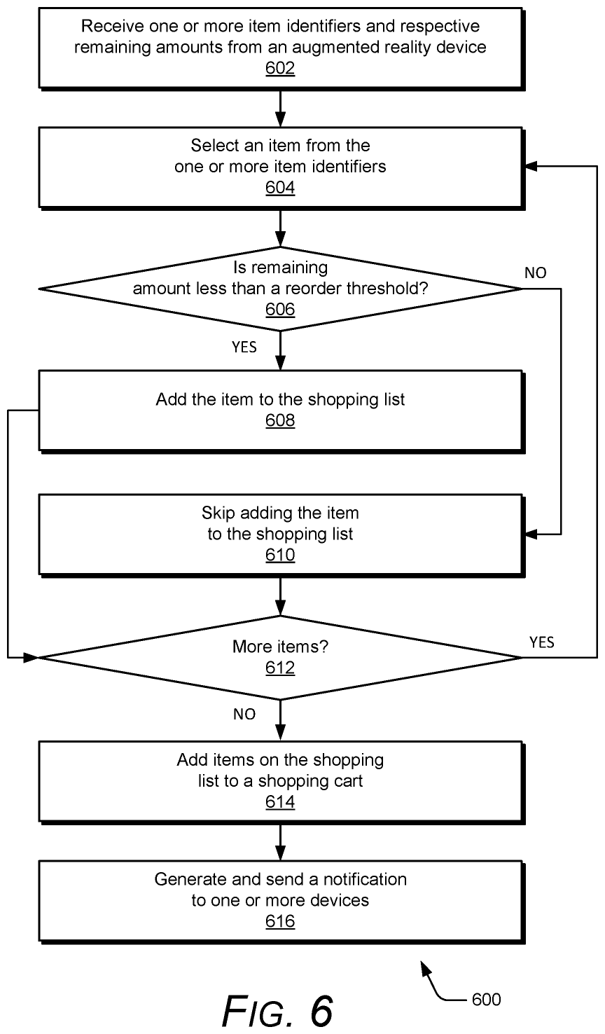

FIG. 6 illustrates example method(s) 600 for automated shopping using augmented reality. The order in which the method is described is not intended to be construed as a limitation, and any number or combination of the method operations described herein (e.g., of FIGS. 3, 4, 5, and/or 6) may be performed in any order to perform a method, or an alternate method.

At 602, one or more item identifiers and respective remaining amounts are received from an augmented reality device. For example, the smart shopping controller 114 monitors the mobile device 102 and receives at least one identifier indicating an item is rice and the amount remaining of the rice. The amount remaining is indicated as a percentage (e.g., 35% remaining out of a predetermined maximum amount), a volume (e.g., 2 cups remaining), and/or a depth (e.g., 5 inches used, and 3 inches remaining).

At 604, an item is selected from the one or more item identifiers. For example, the smart shopping controller 114 receives a first item indicator for rice and a second item indicator for wheat with a remaining amount respective to each item received. Accordingly, the smart shopping controller 114 selects the first item or the second item.

At 606, a determination is made as to whether the remaining amount is less than a reorder threshold. For example, for the selected item, the smart shopping controller 114 compares the remaining amount of the item to a reorder threshold specific to that item. If the remaining amount is below the reorder threshold (i.e., “Yes” from 606), then at 608, the item is added to the shopping list. For example, when the smart shopping controller 114 determines that the amount of the rice is below the reorder threshold for rice, then the smart shopping controller 114 adds an amount of rice to the shopping list. The smart shopping controller 114 determines the amount of a given item to add to the shopping list based on user preference, a default amount, historical usage, and/or a calendar event.

If the remaining amount is not below the reorder threshold (i.e., “No” from 606), then at 610, the method skips adding the item to the shopping list. For example, when the smart shopping controller 114 determines that the amount of rice is above the reorder threshold for rice, then the smart shopping controller 114 blocks rice being added to the shopping list.

At 612, a determination is made as to whether there are more items to analyze. For example, the smart shopping controller 114 determines whether there are more items to analyze based on the number of items received at 602. If there are more items to analyze (i.e., “Yes” from 612), then at 604, a next item is selected from the one or more item identifiers received at 602. If there are no more items to analyze (i.e., “No” from 612), then at 614, items on the shopping list are added to a shopping cart. For example, the smart shopping controller 114 adds a determined amount of rice to the shopping cart, a determined amount of wheat to the shopping cart, and so on.

At 616, a notification is generated and sent to one or more devices. For example, the smart shopping controller 114 generates a notification (e.g., the notification 206) indicating that the shopping cart is populated with items. Additionally or alternatively, the notification requests that the shopping cart be reviewed, modified, and/or approved.

FIG. 7 illustrates various components of an example device 700, which can implement aspects of the techniques and features for automated shopping using augmented reality, as described herein. The example device 700 may be implemented as any of the devices described with reference to the previous FIGS. 1-6, such as any type of a wireless device, mobile device, mobile phone, flip phone, client device, companion device, paired device, display device, tablet, computing, communication, entertainment, gaming, media playback, and/or any other type of computing and/or electronic device. For example, the mobile device 102 and/or the network device 104 described with reference to FIGS. 1-6 may be implemented as the example device 700.

The example device 700 can include various, different communication devices 702 that enable wired and/or wireless communication of device data 704 with other devices. The device data 704 can include any of the various devices data and content that is generated, processed, determined, received, stored, and/or communicated from one computing device to another. Generally, the device data 704 can include any form of audio, video, image, graphics, and/or electronic data that is generated by applications executing on a device. The communication devices 702 can also include transceivers for cellular phone communication and/or for any type of network data communication.

The example device 700 can also include various, different types of data input/output (I/O) interfaces 706, such as data network interfaces that provide connection and/or communication links between the devices, data networks, and other devices. The data I/O interfaces 706 may be used to couple the device to any type of components, peripherals, and/or accessory devices, such as a computer input device that may be integrated with the example device 700. The I/O interfaces 706 may also include data input ports via which any type of data, information, media content, communications, messages, and/or inputs may be received, such as user inputs to the device, as well as any type of audio, video, image, graphics, and/or electronic data received from any content and/or data source.

The example device 700 includes a processor system 708 of one or more processors (e.g., any of microprocessors, controllers, and the like) and/or a processor and memory system implemented as a system-on-chip (SoC) that processes computer-executable instructions. The processor system 708 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device may be implemented with any one or combination of software, hardware, firmware, or fixed logic circuitry that may be implemented in connection with processing and control circuits, which are generally identified at 710. The example device 700 may also include any type of a system bus or other data and command transfer system that couples the various components within the device. A system bus can include any one or combination of different bus structures and architectures, as well as control and data lines.

The example device 700 also includes memory and/or memory devices 712 (e.g., computer-readable storage memory) that enable data storage, such as data storage devices implemented in hardware which may be accessed by a computing device, and that provide persistent storage of data and executable instructions (e.g., software applications, programs, functions, and the like). Examples of the memory devices 712 include volatile memory and non-volatile memory, fixed and removable mobile devices, and any suitable memory device or electronic data storage that maintains data for computing device access. The memory devices 712 can include various implementations of random-access memory (RAM), read-only memory (ROM), flash memory, and other types of storage media in various memory device configurations. The example device 700 may also include a mass storage mobile device.

The memory devices 712 (e.g., as computer-readable storage memory) provide data storage mechanisms, such as to store the device data 704, other types of information and/or electronic data, and various device applications 714 (e.g., software applications and/or modules). For example, an operating system 716 may be maintained as software instructions with a memory device 712 and executed by the processor system 708 as a software application. The device applications 714 may also include a device manager, such as any form of a control application, software application, signal-processing and control module, code that is specific to a particular device, a hardware abstraction layer for a particular device, and so on.

In one or more examples, the device 700 includes a smart shopping controller 718 that implements various aspects of the described features and techniques described herein. In implementations, the device 700 also includes an augmented reality and/or virtual reality (AR/VR) system 720, which may be utilized by and/or integrated with the smart shopping controller 718. The smart shopping controller 718 is implemented with hardware components and/or in software as one of the device applications 714, such as when the example device 700 is implemented as the mobile device 102 and/or the network device 104 described with reference to FIGS. 1-6. An example of the smart shopping controller 718 is the smart shopping controller 114 implemented by the mobile device 102 and/or the smart shopping controller 122 implemented by the network device 104, such as a software application and/or as hardware components in the mobile device 102 and/or in the network device 104. In implementations, the smart shopping controller 718 may include independent processing, memory, and logic components as a computing and/or electronic device integrated with the example device 700. In implementations, the AR/VR system 720 performs the techniques described herein in conjunction with the smart shopping controller 114 and/or the smart shopping controller 122.

The example device 700 can also include a microphone 722 (e.g., to capture an audio recording of a user) and/or camera devices 724 (e.g., to capture video images of one or more items for a shopping list), as well as motion sensors 726, such as may be implemented as components of an inertial measurement unit (IMU). The motion sensors 726 may be implemented with various sensors, such as a gyroscope, an accelerometer, and/or other types of motion sensors to sense motion of the device. The motion sensors 726 can generate sensor data vectors having three-dimensional parameters (e.g., rotational vectors in x, y, and z-axis coordinates) indicating location, position, acceleration, rotational speed, and/or orientation of the device. The example device 700 can also include one or more power sources 728, such as when the device is implemented as a wireless device and/or mobile device. The power sources may include a charging and/or power system, and may be implemented as a flexible strip battery, a rechargeable battery, a charged super-capacitor, and/or any other type of active or passive power source.

The example device 700 can also include an audio and/or video processing system 730 that generates audio data for an audio system 732 and/or generates display data for a display system 734. The audio system and/or the display system may include any types of devices or modules that generate, process, display, and/or otherwise render audio, video, display, and/or image data. Display data and audio signals may be communicated to an audio component and/or to a display component via any type of audio and/or video connection or data link. In implementations, the audio system and/or the display system are integrated components of the example device 700. Alternatively, the audio system and/or the display system are external, peripheral components to the example device.

Although implementations for automated shopping using augmented reality have been described in language specific to features and/or methods, the appended claims are not necessarily limited to the specific features or methods described. Rather, the specific features and methods are disclosed as example implementations for automated shopping using augmented reality, and other equivalent features and methods are intended to be within the scope of the appended claims. Further, various different examples are described, and it is to be appreciated that each described example may be implemented independently or in connection with one or more other described examples. Additional aspects of the techniques, features, and/or methods discussed herein relate to one or more of the following:

A mobile device, comprising: at least one memory; and at least one processor coupled with the at least one memory configured to cause the mobile device to: detect an item in an image captured by a camera of the mobile device; identify, utilizing augmented reality, that the item is on a list of monitored items that are replenished based on automated ordering; and determine that a remaining quantity of the item is less than a reorder threshold, from which an automated order of the item is initiated.

Alternatively, or in addition to the above-described mobile device, any one or combination of: the at least one processor is configured to cause the mobile device to determine the remaining quantity of the item utilizing the augmented reality for image analysis of one or more previously captured images that include a depiction of the item. The at least one processor is configured to cause the mobile device to display, over a depiction of the item, an item identifier and at least one of an indication of the remaining quantity of the item, or a visual indicator of the reorder threshold relative to the remaining quantity of the item. The at least one processor is configured to cause the mobile device to: identify, utilizing the augmented reality, a new item that is unaccounted for in the list of monitored items; display an identification request over a depiction of the new item; and add an identification of the new item to the list of monitored items based on an identification input response. The at least one processor is configured to cause the mobile device to upload the remaining quantity of the item and an item identifier to a network device that generates the automated order of a shopping list with the item included. The at least one processor is configured to cause the mobile device to receive the shopping list for at least one of review, update, or confirmation of the automated order. The at least one processor is configured to cause the mobile device to: identify that the item is at least partially concealed in a container; display, over a depiction of the item, a request to view within the container; and determine the remaining quantity of the item based on an analysis of the remaining quantity of the item relative to at least one of a depth or volume within the container. The mobile device is a wearable device configured to scan an environment to detect items on the list of monitored items and to perform item quantity analysis based on movement of the wearable device in the environment. The mobile device includes at least one of a mobile phone, an augmented reality device, a wearable smart device, or wearable computer glasses.

A network device, comprising: at least one memory; and at least one processor coupled with the at least one memory configured to cause the network device to: receive, from a mobile device, an identification of an item and a remaining quantity of the item; determine that the remaining quantity of the item is less than a reorder threshold, from which an automated order of the item is initiated; add the item to a shopping list based on the determination; and process the automated order based on receiving an approval of the shopping list.

Alternatively, or in addition to the above-described network device, any one or combination of: the at least one processor is configured to cause the network device to add the item to the shopping list based on an estimated time before the item arrives after ordering. The at least one processor is configured to cause the network device to select a quantity of the item to add to the shopping list based on at least one of historical consumption of the item or one or more calendar events that include at least one of a holiday, a vacation, a guest visit, or a guest overnight stay. The at least one processor is configured to cause the network device to transmit a push notification of the shopping list to a user device, the push notification including a user interface with one or more selectable options to perform at least one of review of the shopping list, modification of the shopping list, or the approval of the shopping list.

A method, comprising: detecting an item in an image captured by a camera of a mobile device; identifying, via augmented reality, that the item is on a list of monitored items that are replenished based on automated ordering; and determining that a remaining quantity of the item is less than a reorder threshold, from which an automated order of the item is initiated.

Alternatively, or in addition to the above-described method, any one or combination of: the method further comprising determining the remaining quantity of the item utilizing the augmented reality for image analysis of one or more previously captured images that include a depiction of the item. The method further comprising displaying, over a depiction of the item, an item identifier and at least one of an indication of the remaining quantity of the item, or a visual indicator of the reorder threshold relative to the remaining quantity of the item. The method further comprising: identifying, utilizing the augmented reality, a new item that is unaccounted for in the list of monitored items; displaying an identification request over a depiction of the new item; and adding an identification of the new item to the list of monitored items based on an identification input response. The method further comprising uploading the remaining quantity of the item and an item identifier to a network device that generates the automated order of a shopping list with the item included. The method further comprising receiving the shopping list for at least one of review, update, or confirmation of the automated order. The method further comprising: identifying that the item is at least partially concealed in a container; displaying, over a depiction of the item, a request to view within the container; and determining the remaining quantity of the item based on an analysis of the remaining quantity of the item relative to at least one of a depth or volume within the container.

1. A mobile device, comprising:
at least one memory; and
at least one processor coupled with the at least one memory configured to cause the mobile device to:
detect an item in an image captured by a camera of the mobile device;
identify, utilizing augmented reality, that the item is on a list of monitored items that are replenished based on automated ordering; and
determine that a remaining quantity of the item is less than a reorder threshold, from which an automated order of the item is initiated.

2. The mobile device of claim 1, wherein the at least one processor is configured to cause the mobile device to determine the remaining quantity of the item utilizing the augmented reality for image analysis of one or more previously captured images that include a depiction of the item.

3. The mobile device of claim 1, wherein the at least one processor is configured to cause the mobile device to display, over a depiction of the item, an item identifier and at least one of an indication of the remaining quantity of the item, or a visual indicator of the reorder threshold relative to the remaining quantity of the item.

4. The mobile device of claim 1, wherein the at least one processor is configured to cause the mobile device to:
identify, utilizing the augmented reality, a new item that is unaccounted for in the list of monitored items;
display an identification request over a depiction of the new item; and
add an identification of the new item to the list of monitored items based on an identification input response.

5. The mobile device of claim 1, wherein the at least one processor is configured to cause the mobile device to upload the remaining quantity of the item and an item identifier to a network device that generates the automated order of a shopping list with the item included.

6. The mobile device of claim 5, wherein the at least one processor is configured to cause the mobile device to receive the shopping list for at least one of review, update, or confirmation of the automated order.

7. The mobile device of claim 1, wherein the at least one processor is configured to cause the mobile device to:
identify that the item is at least partially concealed in a container;
display, over a depiction of the item, a request to view within the container; and
determine the remaining quantity of the item based on an analysis of the remaining quantity of the item relative to at least one of a depth or volume within the container.

8. The mobile device of claim 1, wherein the mobile device is a wearable device configured to scan an environment to detect items on the list of monitored items and to perform item quantity analysis based on movement of the wearable device in the environment.

9. The mobile device of claim 1, wherein the mobile device includes at least one of a mobile phone, an augmented reality device, a wearable smart device, or wearable computer glasses.

10. A network device, comprising:
at least one memory; and
at least one processor coupled with the at least one memory configured to cause the network device to:
receive, from a mobile device, an identification of an item and a remaining quantity of the item;
determine that the remaining quantity of the item is less than a reorder threshold, from which an automated order of the item is initiated;
add the item to a shopping list based on the determination; and
process the automated order based on receiving an approval of the shopping list.

11. The network device of claim 10, wherein the at least one processor is configured to cause the network device to add the item to the shopping list based on an estimated time before the item arrives after ordering.

12. The network device of claim 10, wherein the at least one processor is configured to cause the network device to select a quantity of the item to add to the shopping list based on at least one of historical consumption of the item or one or more calendar events that include at least one of a holiday, a vacation, a guest visit, or a guest overnight stay.

13. The network device of claim 10, wherein the at least one processor is configured to cause the network device to transmit a push notification of the shopping list to a user device, the push notification including a user interface with one or more selectable options to perform at least one of review of the shopping list, modification of the shopping list, or the approval of the shopping list.

14. A method, comprising:
detecting an item in an image captured by a camera of a mobile device;
identifying, via augmented reality, that the item is on a list of monitored items that are replenished based on automated ordering; and
determining that a remaining quantity of the item is less than a reorder threshold, from which an automated order of the item is initiated.

15. The method of claim 14, further comprising determining the remaining quantity of the item utilizing the augmented reality for image analysis of one or more previously captured images that include a depiction of the item.

16. The method of claim 14, further comprising displaying, over a depiction of the item, an item identifier and at least one of an indication of the remaining quantity of the item, or a visual indicator of the reorder threshold relative to the remaining quantity of the item.

17. The method of claim 14, further comprising:
identifying, utilizing the augmented reality, a new item that is unaccounted for in the list of monitored items;
displaying an identification request over a depiction of the new item; and
adding an identification of the new item to the list of monitored items based on an identification input response.

18. The method of claim 14, further comprising uploading the remaining quantity of the item and an item identifier to a network device that generates the automated order of a shopping list with the item included.

19. The method of claim 18, further comprising receiving the shopping list for at least one of review, update, or confirmation of the automated order.

20. The method of claim 14, further comprising:
identifying that the item is at least partially concealed in a container;
displaying, over a depiction of the item, a request to view within the container; and
determining the remaining quantity of the item based on an analysis of the remaining quantity of the item relative to at least one of a depth or volume within the container.
